(19) United States
(12) Patent Application Publication
(10) Pub. No.: US 2009/0153824 A1
(43) Pub. Date: Jun. 18, 2009

(54) MULTIPLE CHUCK SCANNING STAGE

(75) Inventor: AVIV BALAN, Mountain View, CA (US)

Correspondence Address: JDI Patent- KLA-Tencor Corp. Joint Customer Number, Joshua D. Isenberg/ JDI Patent, 809 Corporate Way, Fremont, CA, 94539, US

(73) Assignee: KLA-Tencor Corporation, San Jose, CA (US)

(21) Appl. No.: 11/958,201

(22) Filed: Dec. 17, 2007

(51) Int. Cl. G03B 27/42; G03B 27/54; G03B 27/58

(52) U.S. Cl. 355/67; 355/72; 355/77

(57) ABSTRACT

A substrate processing system and method are disclosed. The system may include a stage, first and second chucks mounted on the stage and at least one processing head proximate the stage. The stage and processing head are configured for relative movement for a sufficient distance for the processing head to process both the first and second test substrates. According to the substrate processing method first and second substrates may be disposed on chucks mounted to a stage. The stage and a processing head may move relative to each other in a first direction along a first axis for a first distance that is sufficient for a substrate processing head to scan across the substrates, then move relative to each other along a direction nonparallel to the first direction for a second distance, and then move relative each other opposite the first direction for a distance sufficient for the head to scan across the substrates. The processing head may process the first and second substrates at one or more locations along the first distance and/or third distance.

### FIELD OF THE INVENTION

This invention generally relates method and apparatus for metrology and inspection measurements and more particularly to a method and apparatus for increasing throughput of the metrology measurements of the semiconductor wafer.

### BACKGROUND OF THE INVENTION

In semiconductor lithography, a reticle is imaged through a reduction-projection lens onto a wafer below. A scanning exposure device uses simultaneous motion of the reticle and wafer (each mounted on its own X-Y stage) to continuously project a portion of the reticle onto the wafer through projection optics. Scanning, as opposed to exposure of the entire reticle at once, allows for the projection of reticle patterns that exceed in size that of the image field of the projection lens.

As integrated circuit device geometries continue to shrink, manufactures have increasingly turned to optical techniques to perform non-destructive inspection and analysis of semiconductor wafers. Techniques of this type, known generally as optical metrology and inspection, operate by focusing an optical beam from a tool on a portion of a sample and then analyzing the reflected or scattered energy. Optical systems having a higher level of throughput are often required in semiconductor manufacture.

Prior art wafer scanning systems typically scan a wafer relative to an optical head in a serpentine pattern. The wafer is scanned in a horizontal direction (e.g., the x-direction) as measurements of a narrow swath of the wafer are made with the optical head. When the end of the scan in the x-direction is reached, the wafer stops and is then translated a short distance horizontally in a direction perpendicular to the x-direction (the y-direction). The wafer is then scanned in the negative x-direction as measurements are made over a parallel swath. Scan speeds have increased to the point that the scan in the x-direction may be performed in as little as 300 milliseconds. However, the turnaround time, i.e., the time to stop the scan, translate in the y-direction and accelerate to scanning speed, may take up to 250 milliseconds. Consequently, the turnaround time may be a significant portion of the time needed to completely scan a wafer.

Throughput improvement of the existing optical metrology and inspection methods with single head tools puts high demands on different system components. Methods for throughput improvement in an optical inspection system with a single head include reducing the move time, reducing the target acquisition time and reducing the target measurement time. In addition, wafer inspection strategies for design rules smaller than 45 nanometers require a significant increase in the number of measurements per die and per wafer. However, the existing methods have not addressed the turnaround time.

To improve the throughput, conventional optical inspection systems sometimes include one single stage and two optical heads. However the optical heads tend to be expensive.

The prior art also teaches optical inspection systems including two stages with two optical tools for the improvement of the throughput. However, the optical tools tend to be expensive and mechanical, environmental, and electrical disturbances of one tool on the other may cause each stage to experience an absolute position error and vibration during scanning.

It is within this context that embodiments of the present invention arise.

### BRIEF DESCRIPTION OF THE DRAWINGS

Objects and advantages of embodiments of the invention will become apparent upon reading the following detailed description and upon reference to the accompanying drawings in which:

FIG. 1 is a top view of a multiple chuck stage optical system according to an embodiment of the present invention.

FIG. 2 is a side view of the multiple chuck stage optical system of FIG. 1.

FIG. 3A is a schematic diagram illustrating a dual chuck stage substrate processing system having a single processing head according to an alternative embodiment of the present invention.

FIG. 3B is a schematic diagram illustrating a dual chuck stage substrate processing system having two processing heads according to an alternative embodiment of the present invention.

FIG. 4 is a block diagram showing a computing system that may be used in connection with facilitating employment of embodiments of the invention.

### DESCRIPTION OF THE SPECIFIC EMBODIMENTS

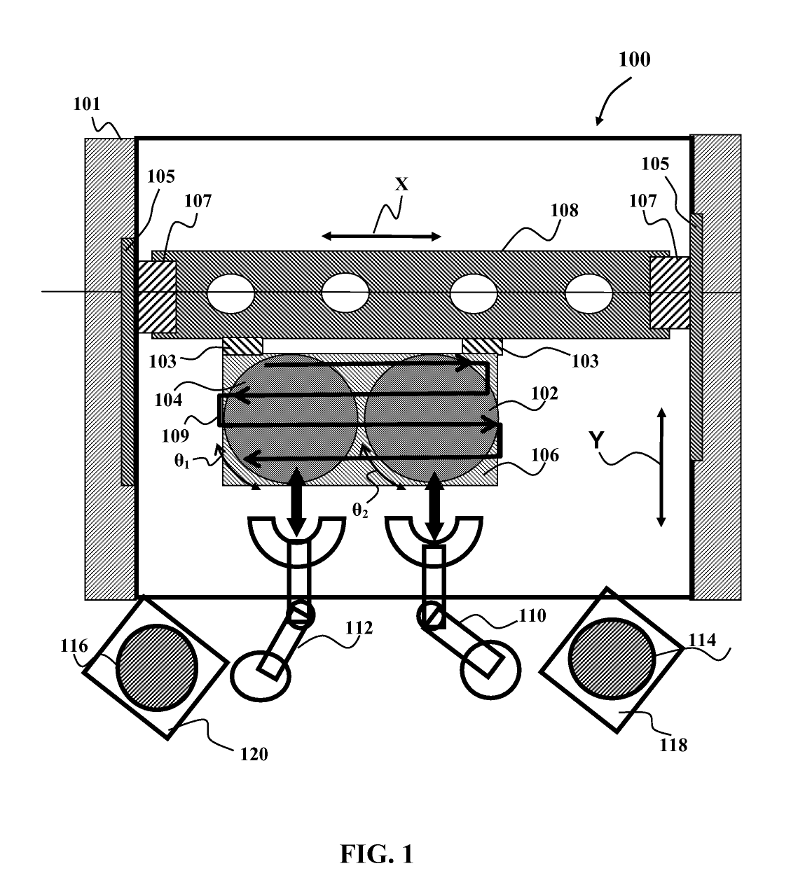

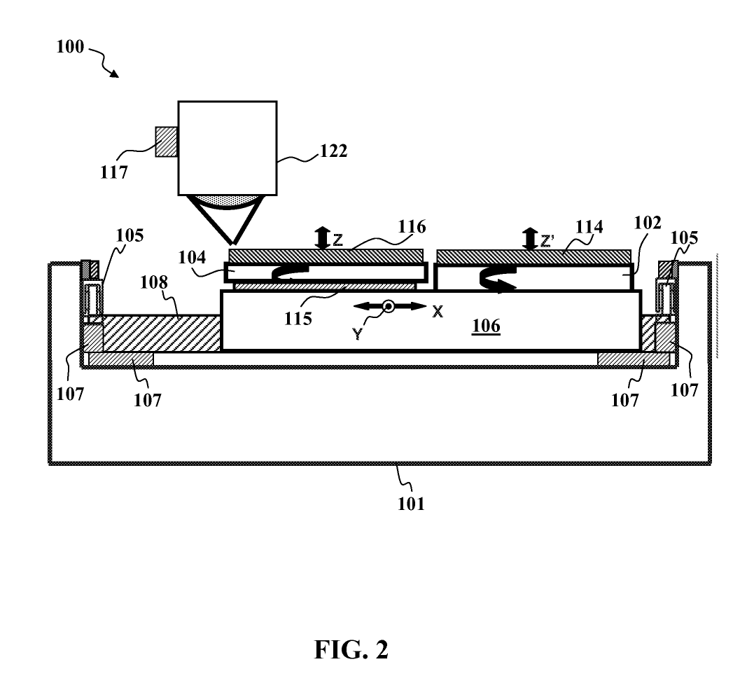

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention. As seen in the top view of FIG. 1 and the side view of FIG. 2, a dual chuck stage optical system 100 according to an embodiment of the present invention may include two or more chucks 102 and 104 mounted on a single stage 106. The stage 106 is very similar to a conventional single chuck stage in its overall construction. The stage may include magnetic levitation (maglev) mechanisms or air bearings or mechanical bearings to allow for smooth movement in the X-Y plane. The principal difference between the stage 106 and a convention single chuck stage is its somewhat greater length, which allows it to accommodate two chucks 102, 104 side-by-side.

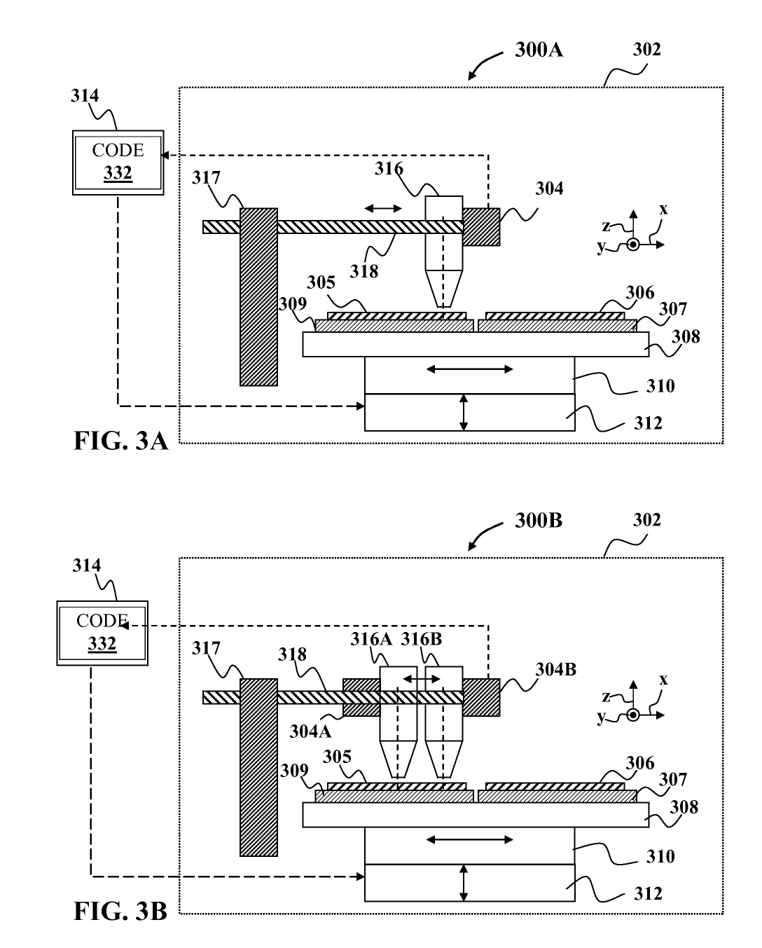

By way of example, one or more X-movement mechanisms 103 may move the stage 106 back and forth along a guide bar beam 108 with respect to an X-axis relative to a base 101, which may be made of granite. One or more Y-movement mechanisms 105 may translate the guide bar beam 108 along with the stage 106 and the chucks 102, 104 with respect a Y-axis. The guide bar beam 108 may be mechanically coupled to the base 101 through bearings 107, which may include air bearings, magnetic levitation bearings or mechanical bearings, such as ball bearings or roller bearings. The X-movement mechanism 103 and Y-movement mechanism 105 may be arranged in a more or less co-planar configuration as shown in FIG. 1 and FIG. 2. Alternatively, a stacked configuration may be used, e.g., as shown in FIG. 3 below.

Through a combination of movements along the X-axis and Y-axis the chucks may be scanned with respect to a substrate processing head 122. The substrate processing head 122 may be configured to facilitate any type of substrate processing that utilizes X-Y scanning. Examples of suitable processing include metrology and inspection, exposure of resists to optical or charged particle (e.g., electron beam) radiation, inkjet printing or spraying of material onto substrates 114, 116 mounted on the chucks 102, 104. By way of example, the substrates 114, 116 may be semiconductor wafers. Alternatively, the substrates 114, 116 may be masks used for photolithography. In the case of metrology or inspection, the processing head 122 may include an optical column coupled to a detector or a source of radiation or both. Such optical columns may be used for mask inspection, wafer inspection and the like. The source of radiation may be a narrow-band source, such as a laser or a broadband source. In some applications, such as mask writing, the optical column may include a reticle with a mask pattern. Radiation may be projected through the reticle onto layers of resist formed on the substrates 114, 116.

In some metrology or inspection tools, the processing head 122 may include an electron beam column, as in a scanning electron microscope (SEM). In some cases, the processing head 122 may include a cantilever probe, as in a scanning probe microscope such as an atomic force microscope (AFM) or scanning tunneling microscope (STM). Electron beam columns may also be used in the processing head 122 for electron beam writing, e.g., to perform patterned exposure of resists on the substrates 114, 116

Each chuck 102, 104 may be configured to retain a substrate, e.g., through vacuum, magnetic or electrostatic force. The stage 106 may be adapted to move both chucks 102 and 104 along a single vertical axis Z if focus adjustment is required, as shown in FIG. 1. Alternatively, and perhaps more preferably, each chuck 102, 104 may individually move in the vertical direction. In addition each chuck 102, 104 may be configured to independently provide tip and tilt adjustment of the orientation of the substrates 114, 116.

In addition the chucks 102, 104 may be adapted to rotate about vertical axes Z, Z′ by angles θ₁, θ₂ respectively, if angular alignment is required as shown in FIG. 2. Two robots 110 and 112 may transfer substrates 114 and 116, e.g., semiconductor wafers, from load ports 118 and 120 to the chucks 102 and 104 or vice versa.

In some applications, it may be desirable to compensate for a Y-offset between the substrates 114, 116. Such an offset may result, e.g., from slight differences in their placement on the chucks 102, 104 by the robots 110, 112. To facilitate compensation of such a Y-offset, one or both of the chucks may include a Y-adjustment mechanism 115 that is configured to make small adjustment to the Y-position of one wafer or the other. The Y-adjustment mechanism 115 may be implemented e.g., using piezoelectric actuators, voice coil actuators, and the like. In the example depicted in FIG. 2, the Y-adjustment mechanism 115 may be configured to provide a sufficient range of movement to in the Y-direction to compensate for any offset in Y-placement between the two substrates 114, 116. The amount of adjustment generally depends on the substrate placement precision. Alternatively, the guide bar beam 108 may be moved slightly in the Y-direction when a scan in the X-direction moves from one substrate to the other in order to account for the offset in Y between the two substrates 114, 116. As another alternative, an offset in Y-placement between the two substrates 114 116 may be similarly compensated by using a Y-adjustment mechanism 117 to move the processing head 122 slightly in the Y-direction.

An optical scanning method according to an embodiment of the invention optical scanning method may be understood by referring to FIG. 1. By way of example, and without loss of generality, both substrates 114 and 116 may be scanned by the processing head 122 as the stage 106 moves in the X- and Y-directions, e.g., in a serpentine pattern 109. The substrates 114, 116 may be disposed on the chucks 102, 104 mounted to the stage 106. The stage 106 may then move relative to the processing head 122 in one direction along the X-axis for a sufficient distance that the processing head 122 can scan across both substrates 114, 116. The processing head 122 may make measurements of the substrates 114, 116 at measurement sites along the scan in the X-direction. At the end of the scan in the X-direction, the stage guide bar beam 108 and stage 106 may move relative to the processing head 122 along a direction nonparallel to the X-axis, e.g., along the Y-axis. This motion need not move the substrates more than about the width of a field of view of the processing head 122. Indeed the movement may along the Y-direction between scans in the X-direction be less than the width of the field of view of the processing head 122. As used herein, the term “field of view” may refer to an area on a surface of a substrate from which the processing head 122 collects radiation or charged particles for generating an image or making a measurement. Alternatively, the term “field of view” may refer to an area on the surface of the substrate that is subject to radiation or charged particles from the processing head 122. In some applications, where the processing head both projects radiation or charged particles onto the surface and collects radiation or charged particles from the surface of the substrate the “field of view” may refer to an intersection of the two areas.

After the guide bar beam 108 and stage 106 have moved a sufficient distance relative to the processing head 122 in the Y-direction, the guide bar beam 108 and stage 106 may move backward relative to the processing head 122 along the X-axis. The movement may be for a sufficient distance that the processing head 122 scans across both the first and second substrates. The processing head 122 may make further measurements of the substrates 114, 116 at measurement sites along the scan in the reverse X-direction. At each measurement site, the stage 106, or a relevant one of the chucks 102, 104 may move in the vertical (Z) direction to adjust a focus of the processing head 122. Alternatively, the processing head 122 may move in the vertical direction at each measurement site to adjust the focus. It is noted that some types processing heads, particularly optical heads, may include a Z-adjustment and use an autofocus to provide feedback on the Z-position relative to the substrates 114, 116. It is noted that in some embodiments, the processing head 122 may move while the two chucks 102, 104 may be kept more or less fixed to achieve an equivalent to moving the two chucks together. In such a case, it is desirable to provide a sufficient range of motion of the processing head 122 in the X-direction to scan across substrates mounted to both chucks 102, 104.

Moving the two chucks together and scanning the processing head 122 across both substrates 114, 116 in the manner described above may reduce the time to process substrates with the system 100. For example, as discussed above, turnaround time of typical single wafer scan may be about 300 ms for a conventional single wafer system. The turnaround time may be defined as the sum of the time to decelerate the stage 106, a settling time, a time to move the stage in the Y-direction, and a time to accelerate the stage 106 to constant velocity in the opposite X-direction. The dual chuck stage structure of the system 100 may cut the total turnaround time by up to 50% since both chucks move together during the time for travel in the Y-direction. Load and unload time may also can be cut up to 50% if two robots 110 and 112 are used. In addition, the time for substrate rotation and alignment may be cut in half if the chucks 102, 104 rotate both substrates simultaneously. Furthermore, because both chucks 102, 104 are mounted to the same stage 106 and move in concert with each other vibrations and other disturbances associated with moving the chucks separately may be practically eliminated.

FIG. 3A is a schematic diagram illustrating a dual chuck stage substrate processing system 300A according to another embodiment of the present invention. As shown in FIG. 3A, the system 300 includes a stage 308, two chucks 307 and 309 mounted on the stage 308. The chucks 307 and 309 are adapted to hold two substrates 305 and 306. The optical system 300 includes a single processing head 316 supported by a supporting structure 318 and positioned proximate the stage 308 to make measurements of the substrates 305 and 306. The processing head 316 may focus an incident beam of radiation or charged particles on either substrate 305 or 306 and detect radiation and/or charged particles that are scattered by, reflected by or otherwise generated by interaction between the incident beam and the substrates 305 or 306.

A movement mechanism, which is not shown in FIG. 3A, may be configured to impart movement to the supporting structure 318, XY stage 310 and Z stage 312 such that the stage 308 and the processing head 316 may move with respect to one another. For example, the stage 308 may move while the processing head 316 remains fixed. Alternatively, the processing head 316 may move while the stage 308 remains fixed. Furthermore, movement may be imparted to both the stage 308 and the processing head 316 such that they move with respect to each other. By appropriate movement, the processing head 316 may be aligned for measurement of one or more measurement targets on either substrate 305 or 306.

The optical system 300 may also include a focusing mechanism 304 positioned proximate the processing head 316 and operably coupled to the head 316. The focusing mechanism is adapted to adjust a focus of the head 316 on the wafers 305 and 306 during the scanning of the substrates 305 and 306. The optical system 300 may also include a controller 314 operably coupled to the focusing mechanism 304 to control the movement of the wafers 305 and 306 and/or the head 316 in response to a signal from a detector incorporated in the focusing mechanism 304 in a direction parallel to an optical axis of the head 316.

The controller 314 may include coded instructions 332 that, when executed, cause the components of the system 300 to move the stage 308 and/or the optical head 316 with respect to one another to align the head 316 for measurement of a measurement target on wafers 305 or 306. The instructions 332 may cause the system 300 to adjust a focus of the head 316 on the substrates 305 and 306 during the scanning of the substrates 305 and 306. The code instructions may be configured to implement serpentine scanning of the substrates 305, 306 in a pattern similar to that depicted in FIG. 1 and described above.

In some applications, it may be desirable for the system 300 to be able to identify the substrate being scanned by the processing head 316. Such identification may be accomplished, e.g., through use of a bar code on the substrate and a bar code reader coupled to the controller 314 to identify the particular wafer on a given one of the chucks 307, 309. The identity of the wafer being scanned may be triggered, e.g., based on the relative position of the processing head 316 and the stage 308. From the relative position, the controller 314 may determine which chuck 307, 309 is being scanned. The controller 314 may then determine which wafer is being scanned by the processing head 316 from an association between the wafers 305, 306 and the chucks 307, 309 based on the bar code.

By way of example, the system 300 may be initially brought into focus at a target position on the substrate 305. During the scanning through the substrates 305 and 306, the focusing mechanism 304 may measure changes in the relative position between the tool 316 and the substrates 305 or 306 as measured along the z-direction that is perpendicular to x- and y-directions. The focusing mechanism 304 may compensate for these changes by directing the z-stage 312 to adjust z-position of the stage 308 in a way that maintains a desired distance between the tool 316 and the substrate 305 or 306 (as measured along the z-direction) during the scanning. Alternatively, the focusing mechanism 304 may be configured to move the processing head 316 in the z-direction to adjust the focus. The tool-sample distance adjustment may be made continuously or intermittently during the movement. The instructions 332 also switch from auto focus to encoder when the head 316 reach the end of the first substrate 305 and until the head 316 reach the second wafer 306, the auto focus is turn back on. The auto focus is then switched to encoder when the head 316 is turn around.

It is also noted that, in some embodiments, the tool-sample distance may be partly or entirely adjusted along the z-direction using a positioning mechanism 317 or a Z stage that can move the processing head 316 relative to the support structure 318 along the z-direction. By way of example, the positioning mechanism 317 may include a piezoelectric actuator, or other actuator, that is responsive to signals from the controller 314. Preferably the range of movement provided by the z-stage 312 and/or positioning mechanism 317 is sufficient to accommodate for changes in focus across the substrate, e.g., due to variation in sample thickness, warping, tilt of the stage 308 and the like.

In a variation on embodiment depicted in FIG. 3A, a substrate processing system 300B may include two or more processing heads 316A, 316B coupled to the supporting structure 318. Each processing head may include its own focusing mechanism 304A, 304B. The use of two or more processing heads may reduce the number of scans required to process the substrates 305, 306.

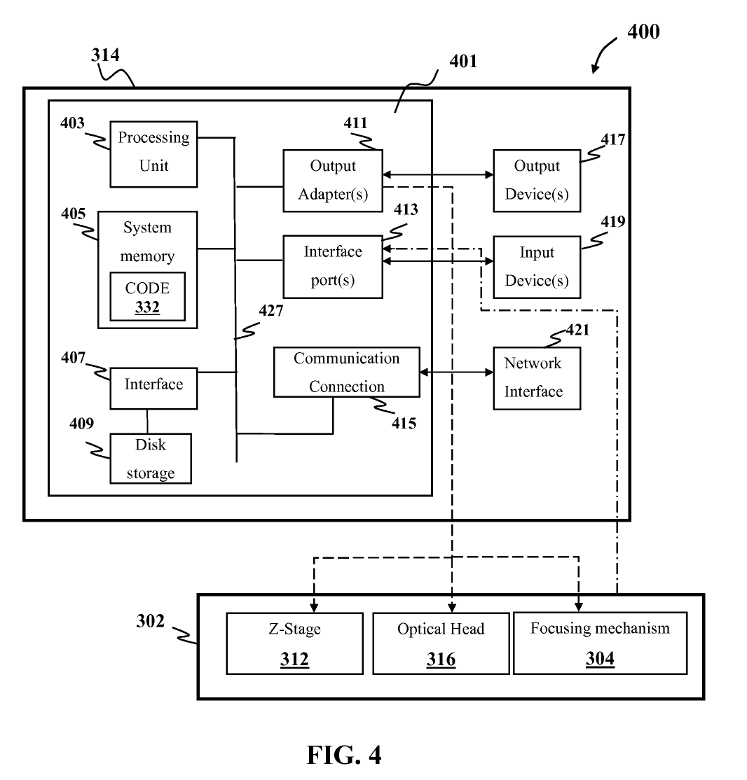

FIG. 4 is a block diagram of an example of an optical system 300A, 300B of the type described above in which a computing system 400 may be used in the controller 314 of FIGS. 3A-3B. The computer system 400 may include a computer 401. The computer 401, e.g., a general-purpose computer, may include a processing unit 403, a system memory 405, and a system bus 427. The system bus 427 couples system components including, but not limited to, the system memory 405 to the processing unit 403. The processing unit 403 can be any of various available processors. The code instructions 332 may be stored in the memory 405 and executed by the processing unit 403.

The system bus 427 can be any of several types of bus structure(s) including a memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 405 may contain the coded instructions 432 described above. The system memory 405 may include volatile memory and/or nonvolatile memory. The basic input/output system (BIOS), comprising the basic routines to transfer information between elements within the computer 401, such as during start-up, may be stored in nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

The computer 401 may optionally include removable/non-removable, volatile/non-volatile computer storage media 409, for example a disk storage. Storage medium 409 may include, but is not limited to, devices like a magnetic disk drive, floppy disk drive, tape drive, Jaz drive, Zip drive, LS-100 drive, flash memory card, or memory stick. In addition, storage medium 409 may include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 409 to the system bus 427, a removable or non-removable interface is typically used such as interface 407.

The computer system 400 may also include one or more input devices 419. Examples of such input devices include a pointing device such as a mouse, trackball, stylus, touch pad, as well as a keyboard, microphone, joystick, and the like. These and other input devices may connect to the processing unit 403 through the system bus 427 via interface port(s) 413. Interface port(s) 413 include, for example, a serial port, a parallel port, a game port, and a universal serial bus (USB). Output device(s) 417 use some of the same type of ports as input device(s) 419. Thus, for example, a USB port can be used to provide input to the computer 401 from a focusing mechanism 404, and to output information from computer 401 to an output device 417 or to the z-stage 312. Output adapter 411 is provided to illustrate that there are some output devices 417 like monitors, speakers, and printers, among other output devices 417, which may require special adapters. The output adapters 411 may include, by way of illustration and not limitation, video and sound cards that provide a means of connection between the output device 417 and the system bus 427.

The computer system 400 may also include a network interface 421 to enable the device to communicate with other the focusing mechanism 304 and/or other devices over a network, e.g., a local area network or a wide area network, such as the internet. Communication connection 415 refers to the hardware/software employed to connect the network interface 421 to the bus 427. While communication connection 415 is shown for illustrative clarity inside computer 401, it can also be external to computer 401. The hardware/software necessary for connection to the network interface 421 includes, for exemplary purposes only, internal and external technologies such as, modems including regular telephone grade modems, cable modems and DSL modems, ISDN adapters, and Ethernet cards.

Dual chuck stage optical systems of the types shown in FIG. 1 through FIG. 4 may be employed in bright and dark field machines, SEM, options mechanical, magnetic, optical, probe for scanning and keep track of image of wafers or other substrate like PCB or processing like coating a wafer using bar codes. Although in the examples described above only two chucks are shown, embodiments of the present invention may be extended to systems and methods involving three or more chucks. In addition, although in the above-described examples, the stage moves relative to the optical head, in embodiments of the invention, the optical head may move relative to the stage or both the stage and optical head may be configured to move relative to each other.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A” or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A substrate processing system, comprising:
a stage;
first and second chucks mounted on the stage, wherein the first and second chucks are adapted to hold first and second substrates; and
at least one substrate processing head positioned proximate the stage adapted to process the first and second substrates,
wherein the stage and processing head are configured for relative movement for a sufficient distance for the processing head to process both the first and second test substrates.

2. The system of claim 1, wherein the first and second chucks are adapted to move independently with respect to a vertical axis.

3. The system of claim 2, wherein the first and second chucks area adapted to tip and/or tilt with respect to the vertical axis.

4. The system of claim 1 wherein the stage or processing head is adapted to move with respect to a vertical axis.

5. The system of claim 1, wherein one or more of the first and second chucks are adapted to rotate independently about a rotation axis.

6. The system of claim 1 further comprising a movement mechanism adapted to move the stage along one or more scanning axes with respect to the processing head.

7. The system of claim 1 further comprising a movement mechanism adapted to move at least one of the stage and processing head with respect to one another.

8. The system of claim 6 wherein the processing head is an optical head.

9. The system of claim 8, further comprising a focusing mechanism operably coupled to the optical head, wherein the focusing mechanism is adapted to adjust a focus of the optical head on the first or second wafers during the scanning.

10. The system of claim 8, further comprising a controller operably coupled to the focusing mechanism and the movement mechanism, wherein the controller is adapted to control the movement of the stage and/or the optical head in response to a signal from the focusing mechanism in a direction parallel to an optical axis of the optical head.

11. The system of claim 1 wherein at least one of the first chuck and the second chuck is configured to move relative to the stage independently of the other of the first chuck and the second chuck for a distance sufficient to compensate for an offset in placement of substrates on the first chuck and the second chuck.

12. The system of claim 1 further comprising at least one robot configured to load and unload the first and second substrate.

13. The system of claim 12 wherein the at least one robot includes a first robot and a second robot, wherein the first and second robots are configured to load and unload substrates on the first chuck and the second chuck at the same time.

14. The system of claim 1, wherein the stage is configured to move relative to the processing head.

15. The system of claim 1, wherein the processing head is configured to move relative to the stage.

16. The system of claim 1 wherein the processing head and stage are configured to move relative to each other.

17. The system of claim 16, wherein the stage is configured to:
move relative to the optical head in a first direction along a first axis for a first distance that is sufficient for the processing head to scan across both the first and second substrates;
move relative to the optical head along a direction nonparallel to the first direction for a second distance;
move relative to the optical head in a third direction that is opposite the first direction for a third distance that is sufficient for the processing head to scan across both the first and second substrates.

18. The system of claim 1, wherein the at least one processing head includes two or more processing heads.

19. An substrate processing method, comprising:
disposing first and second substrates on first and second chucks mounted to a stage;
moving the stage and a single processing head relative to each other in a first direction along a first axis for a first distance that is sufficient for the optical head to scan across both the first and second substrates;
moving the stage and the single processing head relative to each other along a direction nonparallel to the first direction for a second distance;
moving the stage and the single processing head relative each other in a third direction that is opposite the first direction for a third distance that is sufficient for the optical head to scan across both the first and second substrates; and
processing the first and second substrates with the processing head at one or more locations along the first distance and/or third distance.

20. The method of claim 19, further comprising moving the first or second chuck in a vertical direction relative to the processing head.

21. The method of claim 19 wherein moving the first or second chucks in the vertical direction comprises moving one of the first and second chuck vertically independently of the other of the first and second chuck.

22. The method of claim 19 wherein the second distance is less than or equal to a width of a field of view of the optical head.

23. The method of claim 19 wherein moving the stage and the single optical head relative to each other comprises moving the stage while keeping the optical head fixed.

24. The method of claim 19 wherein moving the stage and the single optical head relative to each other comprises moving the optical head while keeping the stage fixed.

25. The method of claim 19 wherein moving the stage and the single optical head relative to each other comprises moving both the optical head and the stage relative to each other.
